(19) United States
(12) Patent Application Publication
(10) Pub. No.: US 2023/0415484 A1
(43) Pub. Date: Dec. 28, 2023

(54) LIQUID DISCHARGE DEVICE

(71) Applicant: BROTHER KOGYO KABUSHIKI KAISHA, Nagoya (JP)

(72) Inventor: Taichiro KIMOTO, Nagoya (JP)

(21) Appl. No.: 18/340,165

(22) Filed: Jun. 23, 2023

(30) Foreign Application Priority Data
Jun. 28, 2022 (JP) 2022-103329

(51) Int. Cl. B41J 2/165; B41J 2/175

(52) U.S. Cl. CPC B41J 2/16526; B41J 2/17566

(57) ABSTRACT

A liquid discharge device includes a tank configured to store a liquid, a head having a plurality of nozzles forming a plurality of nozzle rows, a first sensor configured to output a first signal when a liquid level of the liquid is at or above a first position and to output a second signal when the liquid level is below the first position, and a controller configured to: based on receiving the first signal after receiving the second signal, perform a first maintenance on a part of the nozzle rows of the head; in a case a predetermined condition is satisfied after performing the first maintenance, perform a second maintenance on remaining nozzle rows of the head; and after performing the first and the maintenances, control the head to discharge the liquid from the plurality of nozzles.

### REFERENCE TO RELATED APPLICATIONS

This application claims priority from Japanese Patent Application No. 2022-103329 filed on Jun. 28, 2022. The entire content of the priority application is incorporated herein by reference.

### BACKGROUND ART

A related-art printer includes a tank to which a cartridge for storing ink is installed and stores ink supplied from the mounted cartridge, and a head including a plurality of nozzles for discharging ink supplied from the tank. In such a printer, when a new cartridge is mounted in the tank, ink is supplied from the cartridge to the tank. When an amount of ink stored in the tank exceeds a predetermined amount, the printer introduces the ink into the head.

A related-art image recording device includes a first sensor that detects whether a liquid level of ink is higher than a first position and a second sensor that detects whether the liquid level of ink is higher than a second position above the first position. The image recording device notifies that a remaining amount of ink is small when the liquid level of ink becomes lower than the first position after the liquid level of ink becomes lower than the second position, and cancels the notification when the liquid level of ink becomes higher than the first position after the cartridge is mounted.

### DESCRIPTION

When a head includes a plurality of nozzle rows, a printer in the related art may introduce ink into the head after an amount of ink that can be introduced into all of the nozzle rows is stored in a tank. However, in this configuration, since it takes time for the amount of ink stored in the tank to reach a required amount, a time from when the cartridge is mounted to when discharge of ink is started becomes long.

Illustrative aspects of the present disclosure provide a device enabling starting discharge of a liquid early in a case where the liquid is newly supplied.

One illustrative aspect of the present disclosure provides a liquid discharge device including a tank configured to store a liquid, a head having a plurality of nozzles configured to discharge the liquid supplied from the tank, the plurality of nozzles forming a plurality of nozzle rows arranged in a first direction, a first sensor configured to output a signal in accordance with a liquid level of the liquid stored in the tank or of a cartridge supplying the liquid to the tank, and a controller. The first sensor is configured to: output a first signal in a case the liquid level is at or above a first position; and output a second signal in a case the liquid level is below the first position. The controller is configured to: based on receiving the first signal after receiving the second signal from the first sensor, perform a first maintenance on a part of the nozzle rows of the head; in a case a predetermined condition is satisfied after performing the first maintenance, perform a second maintenance on remaining nozzle rows of the head; and after performing the first maintenance and the second maintenance, control the head to discharge the liquid from the plurality of nozzles onto a sheet.

By performing a maintenance process for a part of the nozzle rows in advance in response to the liquid level of the liquid reaching the first position, and thereafter performing the maintenance process for the remaining nozzle rows in response to a predetermined condition being satisfied, it is possible to start the maintenance process earlier and start discharge of the liquid earlier when the liquid is newly supplied.

According to the illustrative aspects of the present disclosure, it is possible to start discharge of a liquid early when the liquid is newly supplied.

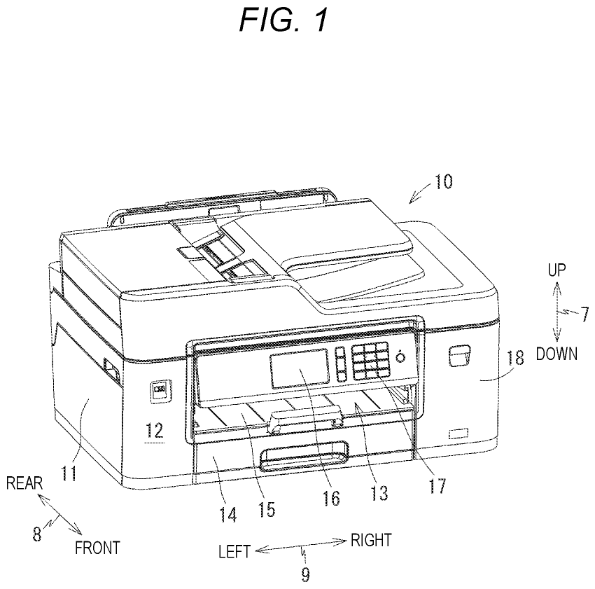

FIG. 1 is an external perspective view of a printer 10 according to an illustrative embodiment of the present disclosure.

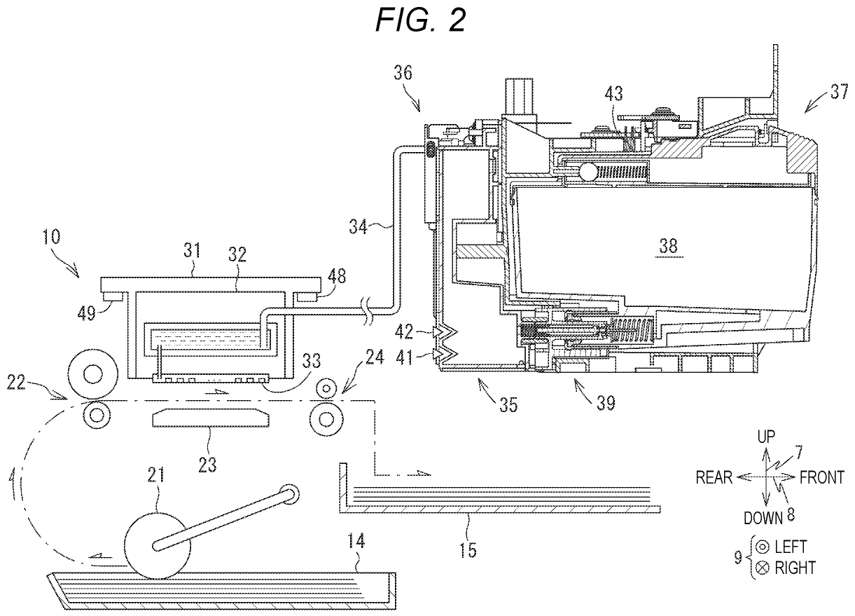

FIG. 2 is a longitudinal sectional view illustrating an internal structure of the printer 10.

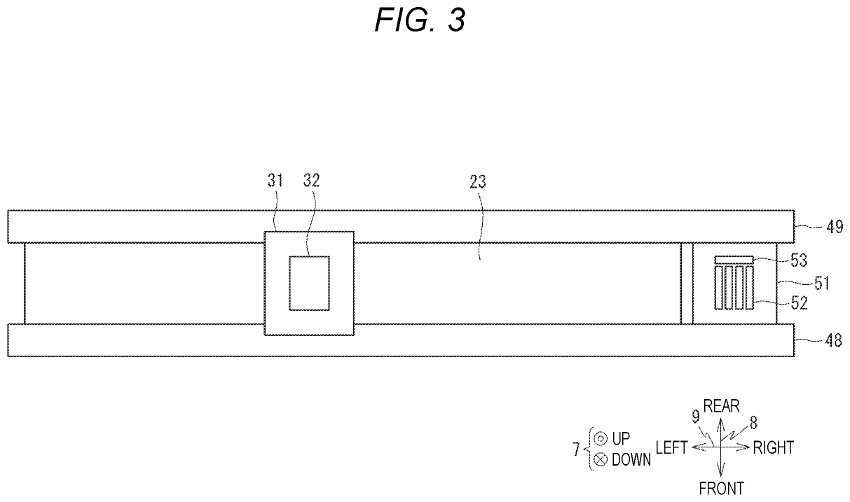

FIG. 3 is a diagram illustrating a moving range of a carriage 31.

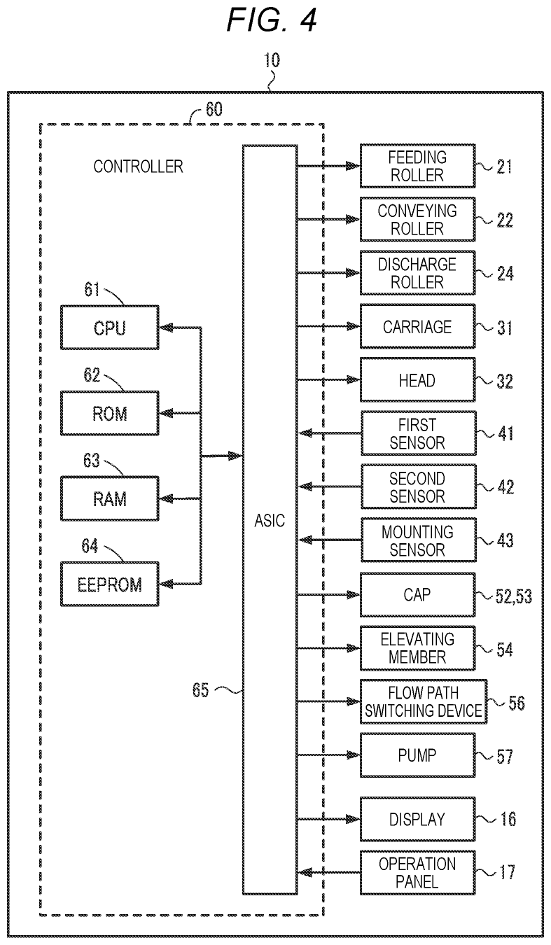

FIG. 4 is a block diagram of the printer 10.

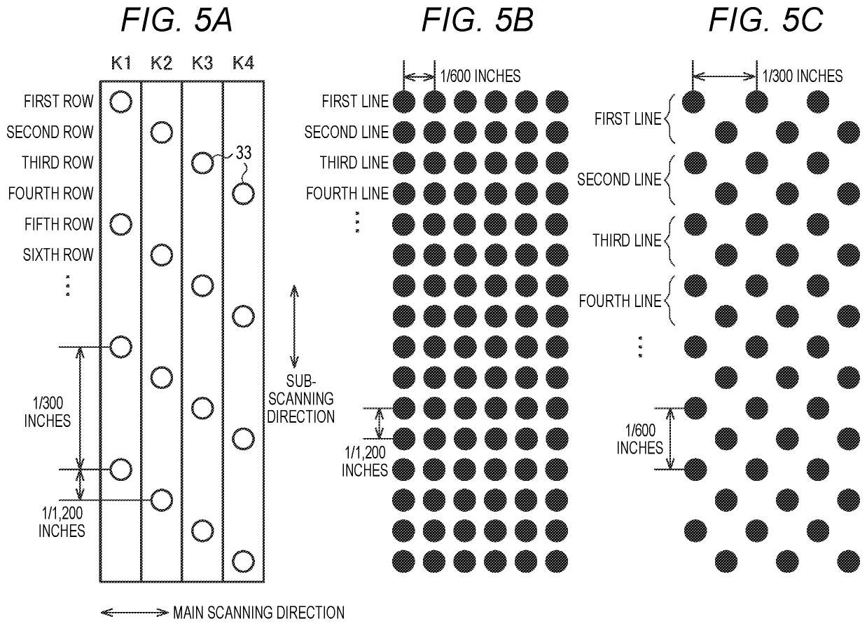

FIG. 5A is a diagram illustrating an arrangement of nozzles 33 in a head 32, FIG. 5B is an enlarged view of an image printed in a high image quality mode, and FIG. 5C is an enlarged view of an image printed in a high-speed mode.

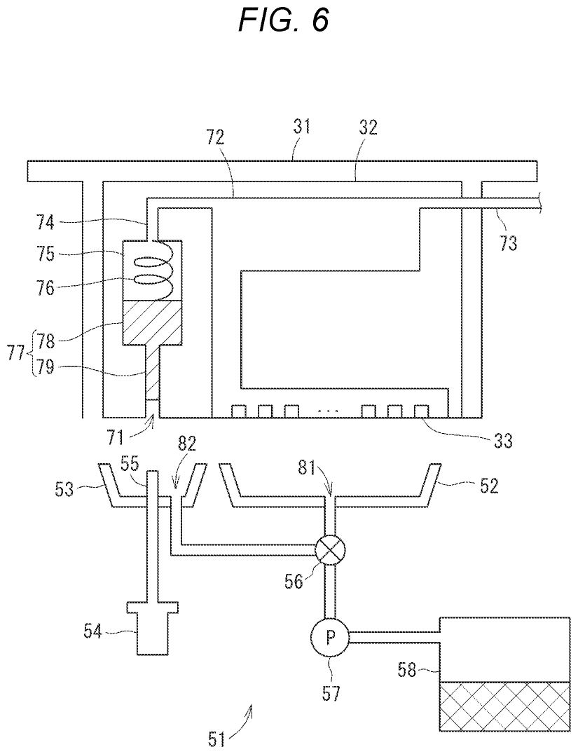

FIG. 6 is a diagram illustrating a configuration of a maintenance mechanism 51.

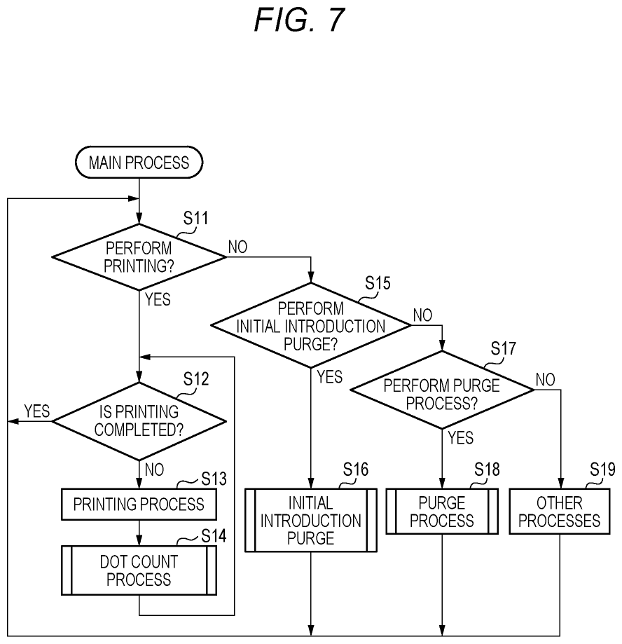

FIG. 7 is a flowchart of a main process.

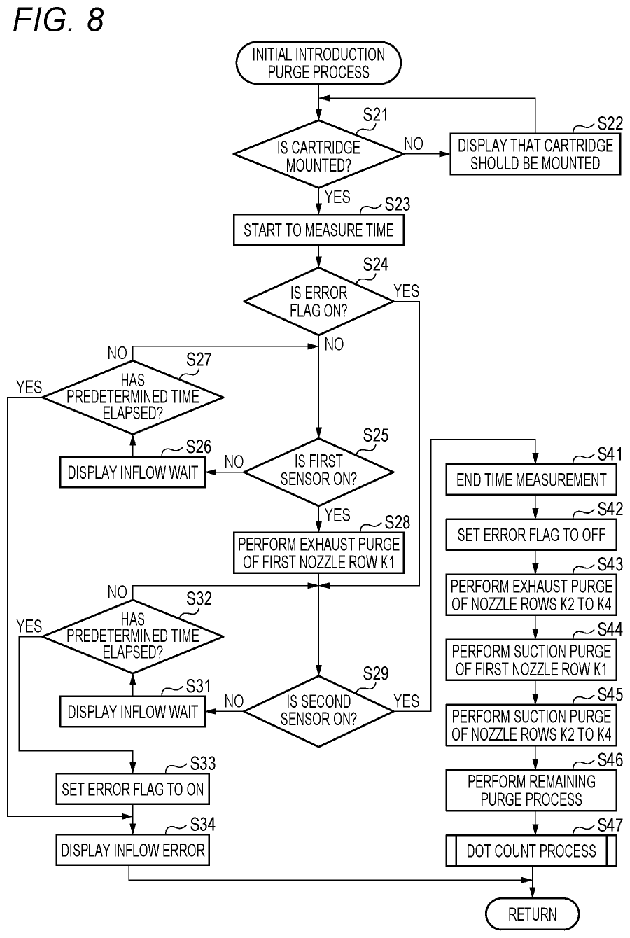

FIG. 8 is a flowchart of an initial introduction purge process.

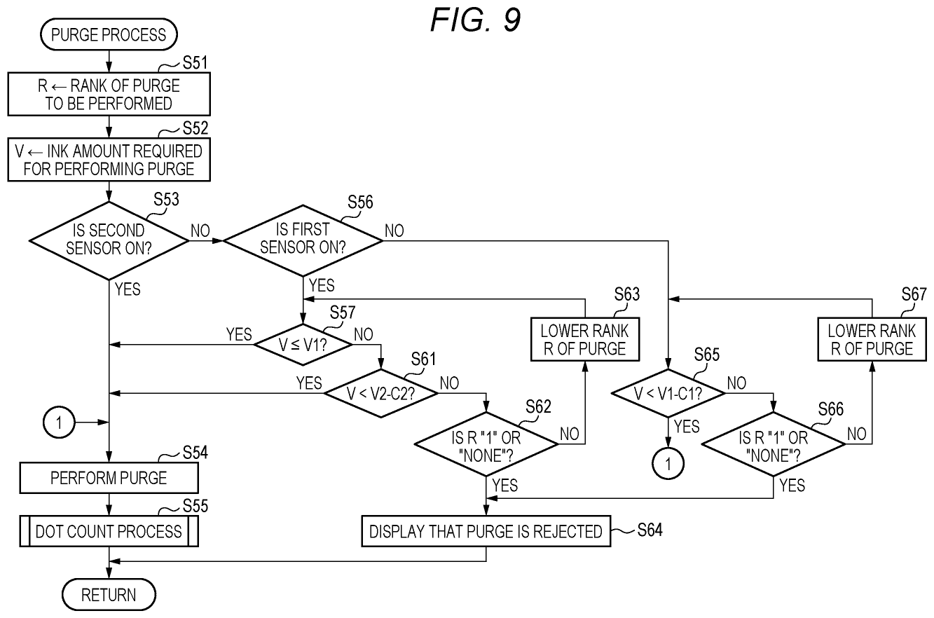

FIG. 9 is a flowchart of a purge process.

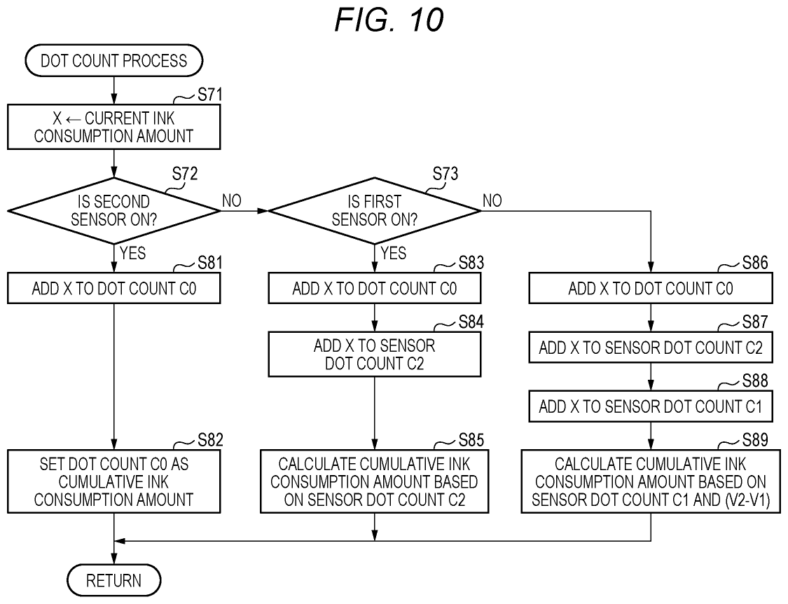

FIG. 10 is a flowchart of a dot count process.

Hereinafter, an illustrative embodiment of the present disclosure will be described. The illustrative embodiment described below is merely an example of the present disclosure, and it is needless to say that the illustrative embodiment of the present disclosure can be appropriately modified without departing from the scope of the present invention. In the following description, an advancing direction from a start point to an end point of an arrow is expressed as an orientation, and advancing directions on a line connecting the start point and the end point of the arrow is expressed as directions. In addition, an up-down direction 7 is defined with reference to a state where the printer 10 is installed so as to be usable (a state in FIG. 1), a front-rear direction 8 is defined with a surface of the printer 10 on which an opening 13 is formed as a front surface, and a left-right direction 9 is defined when the printer 10 is viewed from the front surface. The up-down direction 7, the front-rear direction 8, and the left-right direction 9 are orthogonal to one another.

{Overview of Printer 10}

The printer 10 according to the present illustrative embodiment is an example of a liquid discharge device that discharges ink (an example of a liquid) onto a sheet by an ink jet printing method. The printer 10 is a monochrome printer that discharges black ink onto a sheet.

The printer 10 has a substantially rectangular parallelepiped housing 11. As illustrated in FIGS. 1 and 2, a feeding tray 14, a feeding roller 21, a conveying roller 22, a carriage 31, a head 32 mounted on the carriage 31 and having a plurality of nozzles 33, a platen 23 facing the head 32, a discharge roller 24, a discharge tray 15, a sub-tank 35, a mounting case 36 on which a cartridge 37 can be mounted, and a tube 34 for communicating the cartridge 37 mounted on the mounting case 36 with the head 32 are located in an inside of the housing 11. The plurality of nozzles 33 are arranged in the front-rear direction 8 on a lower surface of the head 32.

The printer 10 drives the feeding roller 21 and the conveying roller 22 to convey the sheet supported on the feeding tray 14 to a position of the platen 23 along a conveying path (a path indicated by a dashed line in FIG. 2). Next, the printer 10 causes ink supplied from the cartridge 37 mounted in the mounting case 36 via the sub-tank 35 and the tube 34 to be discharged from the nozzles 33 of the head 32. As a result, the ink lands on the sheet supported by the platen 23, and an image to be formed is printed on the sheet. The printer 10 drives the discharge roller 24 to discharge the sheet on which the image is printed to the discharge tray 15.

The carriage 31 is supported by two guide rails 48 and 49 extending in the left-right direction 9, and reciprocates in the left-right direction 9. The printer 10 discharges the ink from the nozzles 33 of the head 32 while the carriage 31 moves in the left-right direction 9. Thus, an image is recorded in a partial region of the sheet facing the head 32. Next, the printer 10 causes the conveying roller 22 to convey the sheet such that a region where an image is to be recorded next faces the head 32. By alternately and repeatedly performing these processes, the image is recorded on the sheet.

As illustrated in FIG. 1, the housing 11 includes a cover 18 at a right end portion of a front surface 12 of the housing 11 in the left-right direction 9. An opening (not illustrated) is formed at a position of the cover 18. The cover 18 is pivotable between a position for closing the opening (a position illustrated in FIG. 1) and a position for opening the opening. One mounting case 36 is located in an accommodation space inside the housing 11 that extends to the back of the opening. The cartridge 37 in which black ink is stored is mounted in the mounting case 36.

The cartridge 37 has a liquid chamber 38 (see FIG. 2) capable of storing ink. When the cartridge 37 is mounted in the mounting case 36, the ink stored in the liquid chamber 38 flows into the sub-tank 35 via an ink flow path 39 that communicates the liquid chamber 38 with the sub-tank 35. The sub-tank 35 temporarily stores the inflowing ink. The ink stored in the sub-tank 35 is supplied to the head 32 via the tube 34.

{Liquid Level Sensor and Mounting Sensor 43}

As illustrated in FIG. 2, a first sensor 41 and a second sensor 42 are located on a rear surface of the sub-tank 35. The second sensor 42 is located above the first sensor 41. The first sensor 41 includes a light emitting element (not illustrated) and a light receiving element (not illustrated) that face each other with the sub-tank 35 interposed therebetween. For example, the light emitting element is located on a left side of the sub-tank 35, and the light receiving element is located on a right side of the sub-tank 35. At least at a position of the first sensor 41 and a position of the second sensor 42, the sub-tank 35 is formed of a material that transmits light.

When a liquid level of the ink stored in the sub-tank 35 is below the position of the first sensor 41, light emitted from the light emitting element enters the light receiving element. In this case, the first sensor 41 outputs, for example, a low level signal. On the other hand, when the liquid level of the ink stored in the sub-tank 35 is at or above the position of the first sensor 41, the light emitted from the light emitting element is scattered due to the ink stored in the sub-tank 35, and an amount of the light entering the light receiving element decreases. In this case, the first sensor 41 outputs, for example, a high level signal. The second sensor 42 has the same configuration as the first sensor 41 and operates in the same manner as the first sensor 41.

A position of the first sensor 41 in the up-down direction 7 is an example of a first position. The high level signal output from the first sensor 41 is an example of a first signal. The low level signal output from the first sensor 41 is an example of a second signal. A position of the second sensor 42 in the up-down direction 7 is an example of a second position. A high level signal output from the second sensor 42 is an example of a third signal. A low level signal output from the second sensor 42 is an example of a fourth signal.

The first sensor 41 outputs the first signal in response to the liquid level of the ink stored in the sub-tank 35 being at or above the first position, and outputs the second signal in response to the liquid level being below the first position. The second sensor 42 outputs the third signal in response to the liquid level of the ink stored in the sub-tank 35 being at or above the second position, and outputs the fourth signal in response to the liquid level being below the second position. In the following description, the first sensor 41 and the second sensor 42 are referred to as ON when a high level signal is output, and are referred to as OFF when a low level signal is output.

The mounting sensor 43 is located above the cartridge 37 mounted in the mounting case 36. The mounting sensor 43 includes a light emitting element (not illustrated) and a light receiving element (not illustrated). A protrusion (not illustrated) for mounting detection is located on an upper surface of the cartridge 37. The protrusion is formed of a material that does not transmit light. In a state where the cartridge 37 is mounted in the mounting case 36, the protrusion is located between the light emitting element and the light receiving element of the mounting sensor 43.

In a state where the cartridge 37 is not mounted in the mounting case 36, light emitted from the light emitting element enters the light receiving element. In this case, the mounting sensor 43 outputs a low level signal. On the other hand, in a state where the cartridge 37 is mounted in the mounting case 36, the light emitted from the light emitting element is blocked by the protrusion and does not enter the light receiving element. In this case, the mounting sensor 43 outputs a high level signal.

In the above description, the first sensor 41, the second sensor 42, and the mounting sensor 43 are optical sensors, but these sensors can be of any configuration. For example, the first sensor 41 and the second sensor 42 may be float sensors or electrode sensors.

{Movement Range of Carriage 31}

As illustrated in FIG. 3, the platen 23 has a shape elongated in the left-right direction 9 and is located below the carriage 31 in the up-down direction 7 (see FIG. 2). A left end of the platen 23 is located near left ends of the guide rails 48 and 49 in the left-right direction 9. A right end of the platen 23 is located to the right of centers of the guide rails 48 and 49 in the left-right direction 9. A maintenance mechanism 51 is located on the right of the platen 23 in the left-right direction 9.

The maintenance mechanism 51 includes four nozzle caps 52 and an exhaust port cap 53. While the printer 10 is performing printing, the carriage 31 moves in the left-right direction 9 within a range of the platen 23. While the printer 10 is not performing printing, the carriage 31 is located at a position (hereinafter, referred to as a standby position) where the head 32 faces the nozzle caps 52 and the exhaust port cap 53.

{Controller 60}

The controller 60 illustrated in FIG. 4 is located in the inside of the housing 11. The controller 60 includes a CPU (which is an abbreviation for Central Processing Unit) 61, an ROM (which is an abbreviation for Read Only Memory) 62, an RAM (which is an abbreviation for Random Access Memory) 63, an EEPROM (which is an abbreviation for Electrically Erasable Programmable Read-Only Memory) 64, and an ASIC (which is an abbreviation for Application-Specific Integrated Circuit) 65. The ROM 62 stores programs for the CPU 61 to perform various processes. The RAM 63 is used as a storage area for temporarily storing data, signals, and the like used when the CPU 61 executes a program, or a work area for data processing. The EEPROM 64 stores information to be held even after the power is turned off.

The controller 60 controls the feeding roller 21, the conveying roller 22, the discharge roller 24, the carriage 31, and the head 32. The controller 60 rotates the feeding roller 21, the conveying roller 22, and the discharge roller 24 by driving a motor (not illustrated) via the ASIC 65. The controller 60 moves the carriage 31 in the left-right direction 9 by driving the motor (not illustrated) via the ASIC 65. The controller 60 causes ink to be discharged from the nozzles 33 of the head 32 by outputting a driving signal to a driving element (not illustrated) of the head 32 via the ASIC 65. The ASIC 65 outputs a driving signal corresponding to an amount of the ink to be discharged from the nozzles 33.

The controller 60 receives signals output from the first sensor 41, the second sensor 42, and the mounting sensor 43 via the ASIC 65. The controller 60 detects whether the liquid level of the ink stored in the sub-tank 35 is at or above the position of the first sensor 41 based on the signal received from the first sensor 41. The controller 60 detects whether the liquid level of the ink stored in the sub-tank 35 is at or above the position of the second sensor 42 based on the signal received from the second sensor 42. The controller 60 detects whether the cartridge 37 is mounted in the mounting case 36 based on the signal received from the mounting sensor 43.

The controller 60 controls each unit of the maintenance mechanism 51. The controller 60 moves the nozzle caps 52 and the exhaust port cap 53 together in the up-down direction 7 by driving the motor (not illustrated) via the ASIC 65. The controller 60 moves an elevating member 54 in the up-down direction 7 by driving the motor (not illustrated) via the ASIC 65. The controller 60 switches a state of a flow path switching device 56 by outputting a control signal via the ASIC 65. The controller 60 operates a pump 57 by outputting a control signal via the ASIC 65. The configuration of the maintenance mechanism 51 will be described later.

A display 16 and an operation panel 17 are connected to the ASIC 65. The display 16 is, for example, a liquid crystal display or an organic EL (which is an abbreviation for Electro Luminescence) display. The display 16 displays, for example, a state of the printer 10 on a screen. The operation panel 17 outputs an operation signal corresponding to an operation by a user to the controller 60. The operation panel 17 may include, for example, a push button or a touch sensor superimposed on the display 16. The display 16 is an example of a notification device.

{Arrangement of Nozzles 33}

FIG. 5A illustrates an arrangement of the nozzles 33 in the head 32. In FIG. 5A, a horizontal direction is a movement direction of the carriage 31, and a vertical direction is a conveying direction of the sheet. In the following description, the former is referred to as a main scanning direction, and the latter is referred to as a sub-scanning direction. In the present illustrative embodiment, the main scanning direction and the sub-scanning direction are orthogonal to each other. White circles illustrated in FIG. 5A show positions of the nozzles 33 when the head 32 is viewed from above.

The head 32 includes a first nozzle row K1, a second nozzle row K2, a third nozzle row K3, and a fourth nozzle row K4. The first nozzle row K1 includes a plurality of nozzles 33 arranged at a pitch P in the sub-scanning direction (an example of a first direction). In any of the second to fourth nozzle rows K2 to K4, the same number of nozzles 33 as in the first nozzle row K1 are arranged at the same pitch P in the sub-scanning direction. In the present illustrative embodiment, the pitch P is 1/300 inches. The second nozzle row K2 is located on the right of the first nozzle row K1. The third nozzle row K3 is located on the right of the second nozzle row K2. The fourth nozzle row K4 is located on the right of the third nozzle row K3. A distance between two nozzle rows in the main scanning direction is freely set.

Positions of the nozzles 33 in the second nozzle row K2 in the sub-scanning direction are shifted from positions of the nozzles 33 in the first nozzle row K1 in the sub-scanning direction by a quarter of the pitch P (for example, 1/1,200 inches). Positions of the nozzles 33 in the third nozzle row K3 in the sub-scanning direction are shifted by half the pitch P from the positions of the nozzles 33 in the first nozzle row K1 in the sub-scanning direction. Positions of the nozzles 33 in the fourth nozzle row K4 in the sub-scanning direction are shifted from the positions of the nozzles 33 in the first nozzle row K1 in the sub-scanning direction by three quarters of the pitch P.

The nozzles 33 in the first to fourth nozzle rows K1 to K4 are divided into four groups in an arrangement order in the sub-scanning direction, and four nozzles 33 in each group correspond to one another. For example, the nozzles 33 located in first to fourth rows correspond to one another, and the nozzles 33 located in fifth to eighth rows correspond to one another.

Although FIG. 5A illustrates four nozzles 33 for each nozzle row, the number of nozzles 33 in each nozzle row is actually greater than four. Although the head 32 includes four nozzle rows, the head 32 may include two, three, or five or more nozzle rows.

As a method of arranging the plurality of nozzles 33 in a mode illustrated in FIG. 5A, in addition to a method of forming the plurality of nozzles 33 in the head 32 such that the positions in the sub-scanning direction are different for each nozzle row, there is a method of forming the plurality of nozzles 33 in the head 32 such that the positions in the sub-scanning direction are the same between the nozzle rows, and attaching the head 32 to the carriage 31 by tilting the head 32 by a small angle (by rotating the head 32 by a small angle in a horizontal plane).

{Operation Mode of Printer 10}

The printer 10 operates in either a high image quality mode or a high-speed mode. FIG. 5B illustrates an enlarged image printed in the high image quality mode. FIG. 5C illustrates an enlarged image printed in the high-speed mode. Black circles illustrated in FIGS. 5B and 5C indicate dots formed by the ink discharged from the nozzles 33.

In the high image quality mode (FIG. 5B), the carriage 31 moves at a predetermined speed in the main scanning direction, and every time the carriage 31 moves 1/600 inches in the main scanning direction, the ink is discharged from the nozzles 33 in the first to fourth nozzle rows K1 to K4. In this case, one line of an image is formed by a dot group formed by the ink discharged from one nozzle 33. Accordingly, in the high image quality mode, an image having a resolution of 600 dpi in the main scanning direction and a resolution of 1,200 dpi in the sub-scanning direction is formed on the sheet.

In the high-speed mode (FIG. 5C), the carriage 31 moves in the main scanning direction at a speed higher than that in the high image quality mode, and every time the carriage 31 moves 1/300 inches in the main scanning direction, the ink is discharged from the nozzles 33 in the first to fourth nozzle rows K1 to K4. However, a discharge timing of the ink from the nozzles 33 in the second nozzle row K2 and the fourth nozzle row K4 is delayed such that a landing position of the ink discharged from these nozzles 33 is shifted by 1/600 inches in the main scanning direction of the carriage 31 with respect to a landing position of the ink discharged from the nozzles 33 in the first nozzle row K1 and the third nozzle row K3.

In this case, one line of the image is formed by a dot group formed by the ink discharged from one nozzle 33 and a dot group formed by the ink discharged from adjacent nozzles 33. Specifically, odd-numbered lines of the image are formed by a dot group formed by the ink discharged from the nozzles 33 in the first nozzle row K1 and a dot group formed by the ink discharged from the nozzles 33 in the second nozzle row K2. Even-numbered lines of the image are formed by a dot group formed by the ink discharged from the nozzles 33 in the third nozzle row K3 and a dot group formed by the ink discharged from the nozzles 33 in the fourth nozzle row K4. An interval between the dots in the main scanning direction is 1/600 inches. Accordingly, in the high-speed mode, an image having a resolution of 600 dpi in the main scanning direction and a resolution of 600 dpi in the sub-scanning direction is printed.

{Maintenance Mechanism 51}

FIG. 6 illustrates a portion of the head 32 corresponding to one nozzle row, and the configuration of the maintenance mechanism 51. On the lower surface of the head 32, the first to fourth nozzle rows K1 to K4 in which the plurality of nozzles 33 are arranged in the sub-scanning direction, and four exhaust ports 71 respectively corresponding to the nozzle rows are located. In FIG. 6, one nozzle row and the exhaust port 71 corresponding to the one nozzle row are illustrated.

When the carriage 31 is located at the standby position, the nozzle cap 52 faces the nozzle row, and the exhaust port cap 53 faces the exhaust port 71. An ink flow path 72 that connects an ink inflow port 73 and the nozzles 33 is formed inside the head 32. The exhaust port 71 is connected to an upper portion of the ink flow path 72 via a flow path 74.

The flow path 74 has a diameter-enlarged portion 75. A spring 76 and a valve body 77 are located in an internal space of the diameter-enlarged portion 75. The valve body 77 includes a main body portion 78 and a protruding portion 79. The main body portion 78 has an outer diameter substantially equal to an inner diameter of the diameter-enlarged portion 75, and is located in the diameter-enlarged portion 75. The protruding portion 79 has an outer diameter smaller than the inner diameter of the diameter-enlarged portion 75, and protrudes downward from the diameter-enlarged portion 75 toward the exhaust port 71. The spring 76 is located above the valve body 77 and biases the valve body 77 downward. In a normal state, the main body portion 78 is pressed against a bottom surface of the diameter-enlarged portion 75 by an action of the spring 76, and the exhaust port 71 is in a closed state. The elevating member 54 having a contact portion 55 protruding upward is located below the exhaust port cap 53.

Under control of the controller 60, the nozzle cap 52 and the exhaust port cap 53 move up and down between a position in contact with the lower surface of the head 32 (hereinafter, referred to as a covering position) and a position separated from the lower surface of the head 32 (hereinafter, referred to as a separated position). When the carriage 31 is located at the standby position, the nozzle cap 52 and the exhaust port cap 53 are located at the covering position. In this case, the nozzle cap 52 contacts the periphery of the nozzle row to cover the nozzle row, and the exhaust port cap 53 contacts the periphery of the exhaust port 71 to cover the exhaust port 71. When the carriage 31 is located at a position other than the standby position, the nozzle cap 52 and the exhaust port cap 53 are located at the separated position. In this case, the nozzle cap 52 is located at a position separated downward from the periphery of the nozzle row, and the exhaust port cap 53 is located at a position separated downward from the periphery of the exhaust port 71.

A bottom surface of the nozzle cap 52 has a discharge port 81. An internal space of the nozzle cap 52 is connected to a terminal of the flow path switching device 56 via the discharge port 81. A bottom surface of the exhaust port cap 53 has a discharge port 82. An internal space of the exhaust port cap 53 is connected to another terminal of the flow path switching device 56 via the discharge port 82. Although not illustrated in FIG. 6, the internal space of the nozzle cap 52 corresponding to another nozzle row is connected to the another terminal of the flow path switching device 56. The another terminal of the flow path switching device 56 is connected to one end of the pump 57. The flow path switching device 56 connects any one of the internal space of the exhaust port cap 53 and the internal spaces of the four nozzle caps 52 to one end of the pump 57. The other end of the pump 57 is connected to a waste liquid tank 58. The waste liquid tank 58 stores the ink discharged from the head 32 by the purge process.

The maintenance mechanism 51 includes four elevating members 54 corresponding to the four exhaust ports 71. Under the control of the controller 60, the elevating member 54 moves in the up-down direction 7 between a relatively high contact position and a relatively low non-contact position independently of the nozzle cap 52, the exhaust port cap 53, and other elevating members 54. When the exhaust port cap 53 is located at the covering position and the elevating member 54 is located at the contact position, an upper surface of the contact portion 55 contacts the bottom surface of the protruding portion 79. In this case, the valve body 77 moves upward against a restoration force of the spring 76 and separates from the bottom surface of the diameter-enlarged portion 75. Therefore, the exhaust port 71 is in an opened state.

When the nozzle cap 52 and the exhaust port cap 53 are located at the covering position and the elevating member 54 is located at the non-contact position, the exhaust port 71 is in the closed state. In this state, a suction pressure is applied from the nozzles 33 to the ink flow path 72 by driving the pump 57 after the internal space of the nozzle cap 52 and the pump 57 are connected by the flow path switching device 56. As a result, ink and gas in the ink flow path 72 are discharged from the nozzles 33. The ink discharged from the nozzles 33 is stored in the waste liquid tank 58. In this way, suction purge for sucking the nozzles 33 in the nozzle row is performed.

When the nozzle cap 52 and the exhaust port cap 53 are located at the covering position and the elevating member 54 is located at the contact position, the exhaust port 71 is in the opened state. In this state, a suction pressure is applied from the exhaust port 71 to the ink flow path 72 by driving the pump 57 after the internal space of the exhaust port cap 53 and the pump 57 are connected by the flow path switching device 56. As a result, ink and gas in the ink flow path 72 are discharged from the exhaust port 71. From the exhaust port 71, the gas is mainly discharged. In this way, exhaust purge for sucking the exhaust port 71 of the nozzle row is performed.

By controlling the maintenance mechanism 51, the controller 60 performs the suction purge and the exhaust purge at different timings as a maintenance process of the head 32. By controlling the elevating member 54 and the flow path switching device 56, the controller 60 performs one of the suction purge and the exhaust purge on one or more nozzle rows selected from the first to fourth nozzle rows K1 to K4.

{Main Process}

The controller 60 performs the main process illustrated in FIG. 7 when the CPU 61 executes a program stored in the RAM 63. When conditions are satisfied during performing of the main process, the controller 60 performs an initial introduction purge process (FIG. 8), the purge process (FIG. 9), and a dot count process (FIG. 10).

The main process performed by the controller 60 will be described with reference to FIG. 7. As illustrated in FIG. 7, the controller 60 determines whether to perform printing at the beginning of the main process (S11). In S11, for example, when a print instruction is received from the user, the controller 60 determines to perform the printing. In response to the controller 60 determining to perform the printing (Yes in S11), the process proceeds to S12. In this case, the controller 60 determines whether the printing is completed (S12). In response to the controller 60 determining that the printing is not completed (No in S12), the process proceeds to S13. In this case, the controller 60 performs the printing process (S13) and the dot count process (S14), and the process proceeds to S12. In S13, the controller 60 causes the plurality of nozzles 33 to discharge the ink supplied from the sub-tank 35 onto the sheet. In response to the controller 60 determining that the printing is completed in S12 (Yes in S12), the process proceeds to S11.

In response to the controller 60 determining not to perform the printing in S11 (No in S11), the process proceeds to S15. In this case, the controller 60 determines whether to perform the initial introduction purge (S15). In S15, for example, when an initial introduction purge instruction is received from the user, the controller 60 determines to perform the initial introduction purge. In response to the controller 60 determining to perform the initial introduction purge (Yes in S15), the process proceeds to S16. In this case, the controller 60 performs the initial introduction purge process (S16), and the process proceeds to S11.

In response to the controller 60 determining not to perform the initial introduction purge in S15 (No in S15), the process proceeds to S17. In this case, the controller 60 determines whether to perform the purge process (S17). In the purge process, at least one of the suction purge and the exhaust purge is performed on all the nozzle rows (the first to fourth nozzle rows K1 to K4) included in the head 32. In S17, the controller 60 determines to perform the purge process, for example, when a purge instruction is received from the user or when a predetermined time has elapsed since the purge instruction was performed last time. In response to the controller 60 determining to perform the purge process (Yes in S17), the process proceeds to S18. In this case, the controller 60 performs the purge process (S18), and the process proceeds to S11. In response to the controller 60 determining not to perform the purge process in S17 (No in S17), the process proceeds to S19. In this case, the controller 60 performs other processes (processes other than the printing process, the initial introduction purge process, and the purge process) (S19), and the process proceeds to S11.

{Initial Introduction Purge Process}

The initial introduction purge process performed by the controller 60 will be described with reference to FIG. 8. In the initial introduction purge process, a time after the cartridge 37 is mounted in the mounting case 36 is measured, and an error flag is used. An initial value of the error flag is OFF. The error flag is set to ON when the first sensor 41 is turned ON and the second sensor 42 is not turned ON for a predetermined time after the cartridge 37 is mounted. A state where the error flag is ON is a state where the exhaust purge of the first nozzle row K1 has been performed.

As illustrated in FIG. 8, at the beginning of the initial introduction purge process, the controller 60 determines whether the cartridge 37 is mounted in the mounting case 36 based on a signal received from the mounting sensor 43 (S21). In response to the controller 60 determining that the cartridge 37 is not mounted (No in S21), the process proceeds to S22. In this case, the controller 60 displays on the display 16 that the cartridge should be mounted (S22), and the process proceeds to S21.

In response to the controller 60 determining that the cartridge 37 is mounted in S21 (Yes in S21), the process proceeds to S23. In this case, the controller 60 starts to measure a time (S23). Next, the controller 60 determines whether the error flag is ON (S24). The error flag is set to ON when the exhaust purge of the first nozzle row K1 has been performed, and is set to OFF when the exhaust purge is not performed.

In response to the controller 60 determining that the error flag is not ON (the exhaust purge of the first nozzle row K1 is not performed) (No in S24), the process proceeds to S25. In this case, the controller 60 determines whether the first sensor 41 is ON (S25). The first sensor 41 is determined to be ON when the liquid level of the ink stored in the sub-tank 35 is at or above the position of the first sensor 41, and is determined to be OFF when the liquid level is below the position of the first sensor 41.

In response to the controller 60 determining that the first sensor 41 is not ON (the liquid level is below the position of the first sensor 41) (No in S25), the process proceeds to S26. In this case, the controller 60 displays on the display 16 an inflow wait (S26). Next, the controller 60 determines whether a predetermined time has elapsed (S27). The predetermined time in S27 is a predicted time during which an amount of ink enough for performing the exhaust purge of the first nozzle row K1 is supplied to the sub-tank 35. In response to the controller 60 determining that the predetermined time has not elapsed (No in S27), the process proceeds to S25. In S25 to S27, the controller 60 waits until the liquid level of the ink stored in the sub-tank 35 is at or above the position of the first sensor 41.

In response to the controller 60 determining that the first sensor 41 is ON in S25 (the liquid level is at or above the position of the first sensor 41) (Yes in S25), the process proceeds to S28. In this case, the controller 60 performs the exhaust purge of the first nozzle row K1 (S28). When the liquid level of the ink stored in the sub-tank 35 is at or above the position of the first sensor 41, the controller 60 performs the exhaust purge of the first nozzle row K1.

Next, the controller 60 determines whether the second sensor 42 is ON (S29). The second sensor 42 is determined to be ON when the liquid level of the ink stored in the sub-tank is at or above the position of the second sensor 42, and is determined to be OFF when the liquid level is below the position of the second sensor 42.

In response to the controller 60 determining that the second sensor 42 is not ON (the liquid level is below the position of the second sensor 42) (No in S29), the process proceeds to S31. In this case, the controller 60 displays on the display 16 an inflow wait (S31). Next, the controller 60 determines whether a predetermined time has elapsed (S32). The predetermined time in S32 is a predicted time during which an amount of ink enough for performing the purge in S43 to S46 is supplied to the sub-tank 35, and is equal to or longer than the predetermined time in S27. In response to the controller 60 determining that the predetermined time has not elapsed (No in S32), the process proceeds to S29. In S29, S31, and S32, the controller 60 waits until the liquid level of the ink stored in the sub-tank 35 is at or above the position of the second sensor 42.

In response to the controller 60 determining that the second sensor 42 is ON in S29 (the liquid level is at or above the position of the second sensor 42) (Yes in S29), the process proceeds to S41. In this case, the controller 60 ends the time measurement (S41) and sets the error flag to OFF (S42). Next, the controller 60 sequentially performs the exhaust purge of the second to fourth nozzle rows K2 to K4 (S43), the suction purge of the first nozzle row K1 (S44), and the suction purge of the second to fourth nozzle rows K2 to K4 (S45).

Next, the controller 60 performs the remaining purge process (S46). In S46, the controller 60 repeatedly performs the exhaust purge and the suction purge of the first to fourth nozzle rows K1 to K4 a plurality of times (for example, three times). In this case, the controller detects the liquid level of the ink stored in the sub-tank 35 based on the signals received from the first sensor 41 and the second sensor 42, confirms that a sufficient amount of ink is stored in the sub-tank 35, and then performs each purge process. Next, the controller 60 performs the dot count process (S47), and ends the initial introduction purge process.

In response to the controller 60 determining that the error flag is ON in S24 (the exhaust purge of the first nozzle row K1 has been performed) (Yes in S24), the process proceeds to S29 without performing S25 to S28. When the exhaust purge of the first nozzle row K1 has been performed, the controller 60 waits until the liquid level of the ink stored in the sub-tank 35 is at or above the position of the second sensor 42 without performing the exhaust purge of the first nozzle row K1.

In response to the controller 60 determining that the predetermined time has elapsed in S27 (Yes in S27), the process proceeds to S34. In this case, the controller 60 displays on the display 16 that an inflow error of the ink occurs (S34), and ends the initial introduction purge process.

In response to the controller 60 determining that the predetermined time has elapsed in S32 (Yes in S32), the process proceeds to S33. In this case, the controller 60 sets the error flag to ON (S33), displays on the display 16 that the inflow error of the ink occurs (S34), and ends the initial introduction purge process.

In the initial introduction purge process, S28 is an example of a first maintenance in which a maintenance process is performed on a part of the nozzle rows included in the head 32. The second sensor 42 being ON is an example of the predetermined condition. S43 to S46 are an example of a second maintenance in which a maintenance process is performed on the remaining nozzle rows included in the head 32. In the main process, S13 is an example of a discharge process in which a liquid is discharged from the plurality of nozzles 33 to the sheet after the first maintenance process and the second maintenance process are performed.

When the controller 60 first reaches S25, the liquid level of the ink stored in the sub-tank 35 is low, and the first sensor 41 is OFF. Thereafter, when the ink is supplied from the cartridge 37 to the sub-tank 35 and the liquid level of the ink stored in the sub-tank 35 is at or above the position of the first sensor 41, the first sensor 41 becomes ON. The controller 60 performs S28 (the first maintenance process) in response to a change of the first sensor 41 from OFF to ON (in response to receiving the first signal after the second signal is received from the first sensor 41).

After S28 is performed, the controller 60 performs S43 to S46 (the second maintenance process) in response to determining that the second sensor 42 is ON in S29 (in response to receiving the third signal from the second sensor 42). After S28 is performed, the controller 60 causes the display 16 to operate as the notification device in S34 in response to the second sensor 42 not becoming ON (in response to the third signal not being received from the second sensor 42). After the notification device is caused to operate in S34, the controller 60 does not perform S28 (the first maintenance process) even when the first sensor 41 is ON (even when the first signal is received from the first sensor 41), and performs S43 to S46 (the second maintenance process) in response to determining that the second sensor 42 is ON in S29 (in response to receiving the third signal from the second sensor 42).

{Purge Process}

The purge process performed by the controller 60 will be described with reference to FIG. 9. In the purge process, a rank R of purge to be performed and an ink amount V required for performing the purge are obtained. The rank R of purge is, for example, any one of 1, 2, 3, 4, and “none”. The higher the rank R of purge, the larger the required ink amount V. The rank R of purge “none” indicates that a type of purge is fixed and the rank R of purge cannot be changed.

In the following description, it is assumed that an amount of the ink stored in the sub-tank 35 when the liquid level of the ink is at the position of the first sensor 41 is V1, an amount of the ink stored in the sub-tank 35 when the liquid level of the ink is at the position of the second sensor 42 is V2, an ink consumption amount after the signal output from the first sensor 41 changes from a high level signal to a low level signal (after the liquid level reaches the position of the first sensor 41) is C1, and an ink consumption amount after the signal output from the second sensor 42 changes from a high level signal to a low level signal (after the liquid level reaches the position of the second sensor 42) is C2.

As illustrated in FIG. 9, the controller 60 obtains the rank R of purge to be performed at the beginning of the purge process (S51). In S51, for example, the controller 60 may obtain a rank set by the user as the rank R of purge, or may obtain the rank R of purge based on a ratio or the number of abnormal nozzles obtained by a discharge detection of the nozzles. Next, the controller 60 obtains the ink amount V required for performing the purge (S52). For example, the ROM 62 may store a table in which the rank R of purge is associated with the required ink amount V, and the CPU 61 may read the required ink amount V corresponding to the rank R obtained in S51 from the table stored in the ROM 62.

Next, the controller 60 determines whether the second sensor 42 is ON (whether the liquid level is at or above the position of the second sensor 42) (S53). When the second sensor 42 is ON, a sufficient amount of ink for performing the purge process is stored in the sub-tank 35. In response to the controller 60 determining that the second sensor 42 is ON (Yes in S53), the process proceeds to S54. In this case, the controller 60 performs purge of the rank R (S54) and the dot count process (S55), and ends the purge process.

In response to the controller 60 determining that the second sensor 42 is not ON in S53 (the liquid level is below the position of the second sensor 42) (No in S53), the process proceeds to S56. In this case, the controller 60 determines whether the first sensor 41 is ON (whether the liquid level is at or above the position of the first sensor 41) (S56).

In response to the controller 60 determining that the first sensor 41 is ON (Yes in S56), the process proceeds to S57. In this case, the controller 60 determines whether the required ink amount V is equal to or less than V1 (the ink amount at a time when the first sensor 41 changes from ON to OFF) (S57). When the required ink amount V is equal to or less than V1, an amount of ink required for performing the purge process is stored in the sub-tank 35. In response to the controller 60 determining that the ink amount V is equal to or less than V1 (Yes in S57), the process proceeds to S54. In this case, the controller 60 performs the purge of the rank R (S54) and the dot count process (S55), and ends the purge process.

In response to the controller 60 determining that the ink amount V is not equal to or less than V1 in S57 (No in S57), the process proceeds to S61. In this case, the controller 60 determines whether the ink amount V is less than (V2-C2) (S61). (V2-C2) is an amount of ink stored in the sub-tank 35 at this point in time. When the required ink amount V is less than (V2-C2), the amount of ink required for performing the purge process is stored in the sub-tank 35. In response to the controller 60 determining that the required ink amount V is less than (V2-C2) (Yes in S61), the process proceeds to S54. In this case, the controller 60 performs the purge of the rank R (S54) and the dot count process (S55), and ends the purge process.

In response to the controller 60 determining that the required ink amount V is not less than (V2-C2) in S61 (No in S61), the process proceeds to S62. In this case, the controller 60 determines whether the rank R of purge is “1” or “none” (S62). When the rank R of purge is “1” or “none”, the rank R of purge cannot be lowered. In response to the controller 60 determining that the rank R of purge is “1” or “none” (Yes in S62), the process proceeds to S64. In this case, the controller 60 displays on the display 16 that performing of the purge is rejected (S64), and ends the purge process.

In response to the controller 60 determining that the rank R of purge is neither “1” nor “none” in S62 (No in S62), the process proceeds to S63. In this case, the controller 60 lowers the rank of purge (S63), and the process proceeds to S57. In S63, the controller 60 sets the amount of ink required for performing the purge of the lowered rank R as V.

In response to the controller 60 determining that the first sensor 41 is not ON in S56 (the liquid level is below the position of the first sensor 41) (No in S56), the process proceeds to S65. In this case, the controller 60 determines whether the required ink amount V is less than (V1-C1) (S62). (V1-C1) is an amount of ink stored in the sub-tank 35 at this point in time. When the required ink amount V is less than (V1-C1), the amount of ink required for performing the purge process is stored in the sub-tank 35. In response to the controller 60 determining that the required ink amount V is less than (V1-C1) (Yes in S65), the process proceeds to S54. In this case, the controller 60 performs the purge of the rank R (S54) and the dot count process (S55), and ends the purge process.

In response to the controller 60 determining that the required ink amount V is not less than (V1-C1) in S65 (No in S65), the process proceeds to S66. In this case, the controller 60 determines whether the rank of purge is “1” or “none” (S66). In response to the controller 60 determining that the rank of purge is “1” or “none” (Yes in S66), the process proceeds to S64. In this case, the controller 60 displays on the display 16 that the performing of the purge is rejected (S64), and ends the purge process.

In response to the controller 60 determining that the rank R of purge is neither “1” nor “none” in S66 (No in S66), the process proceeds to S67. In this case, the controller 60 lowers the rank of purge (S67), and the process proceeds to S65. In S67, the controller 60 sets the amount of ink required for performing the purge of the lowered rank R as V.

The purge process is an example of a third maintenance in which a maintenance process is performed on all of the plurality of nozzle rows included in the head 32. In a case where it is determined as Yes in S53, S54 is an example of a maintenance process performed with a liquid having a first amount. S54 performed after S63 is an example of a maintenance process performed with a liquid having a second amount smaller than the first amount.

When performing the third maintenance process in which the maintenance process is performed on all of the plurality of nozzle rows, the controller 60 performs a maintenance process with ink having the first amount in response to receiving the third signal from the second sensor 42, and performs a maintenance process with ink having the second amount smaller than the first amount such that the third maintenance process can be performed with the ink supplied from the sub-tank 35 in response to receiving the fourth signal from the second sensor 42 and the first signal from the first sensor 41.

{Dot Count Process}

The dot count process performed by the controller 60 is described with reference to FIG. 10. In the dot count process, three ink consumption amounts (a dot count C0, a sensor dot count C1, and a sensor dot count C2) are calculated by cumulatively adding ink consumption amounts.

The dot count C0 is an ink consumption amount after an initial state in which a new cartridge 37 is mounted in the mounting case 36. The dot count C0 is reset to 0 at a predetermined timing, and is calculated by cumulatively adding the subsequent ink consumption amounts. The sensor dot count C1 is the C1 described in the purge process, and is the ink consumption amount after the signal received from the first sensor 41 is changed from the high level signal to the low level signal. The sensor dot count C1 is reset to 0 when the signal received from the first sensor 41 changes from the high level signal to the low level signal, and is calculated by cumulatively adding the subsequent ink consumption amounts. The sensor dot count C2 is the C2 described in the purge process, and is the ink consumption amount after the signal received from the second sensor 42 is changed from the high level signal to the low level signal. The sensor dot count C2 is reset to 0 when the signal received from the second sensor 42 changes from the high level signal to the low level signal, and is calculated by cumulatively adding the subsequent ink consumption amounts.

As illustrated in FIG. 10, the controller 60 sets a current ink consumption amount to X at the beginning of the dot count process (S71). The current ink consumption amount X is an amount of ink consumed in the printing process (S13) or the purge process (S28 and S43 to S46, or S54) performed before the dot count process.

Next, the controller 60 determines whether the second sensor 42 is ON (S72). In response to the controller 60 determining that the second sensor 42 is ON (Yes in S72), the process proceeds to S81. In response to the controller 60 determining that the second sensor 42 is not ON (No in S72), the process proceeds to S73. In this case, the controller 60 determines whether the first sensor 41 is ON (S73). In response to the controller 60 determining that the first sensor 41 is ON (Yes in S73), the process proceeds to S83. In response to the controller 60 determining that the first sensor 41 is not ON (No in S73), the process proceeds to S86.

When the liquid level of the ink stored in the sub-tank 35 is at or above the position of the second sensor 42, the controller 60 reaches S81. In this case, the controller 60 adds the ink consumption amount X to the dot count C0 (S81). Next, the controller 60 sets the dot count C0 as a cumulative ink consumption amount (S82).

When the liquid level of the ink stored in the sub-tank 35 is at or above the position of the first sensor 41 and is below the position of the second sensor 42, the controller 60 reaches S83. In this case, the controller 60 adds the ink consumption amount X to the dot count C0 (S83), and also adds the ink consumption amount X to the sensor dot count C2 (S84). Next, the controller 60 calculates a cumulative ink consumption amount based on the sensor dot count C2 (S85). For example, the controller 60 stores the dot count C0 at the time when the second sensor 42 changes from ON to OFF in the RAM 63, and sets a sum of the dot count C0 and the sensor dot count C2 stored in the RAM 63 as the cumulative ink consumption amount in S85.

When the liquid level of the ink stored in the sub-tank 35 is below the position of the first sensor 41, the controller 60 reaches S86. In this case, the controller 60 adds the ink consumption amount X to the dot count C0 (S86), adds the ink consumption amount X to the sensor dot count C2 (S87), and adds the ink consumption amount X to the sensor dot count C1 (S88). Next, the controller 60 calculates an ink consumption amount based on the sensor dot count C1 and (V2-V1) (S89). (V2-V1) is a difference between the amount V2 of the ink stored in the sub-tank 35 when the liquid level of the ink is at the position of the second sensor 42 and the amount V1 of the ink stored in the sub-tank 35 when the liquid level of the ink is at the position of the first sensor 41, and is a fixed value. In S89, the controller 60 sets a sum of the dot count C0, the sensor dot count C1, and (V2-V1) at the time when the second sensor 42 changes from ON to OFF, which are stored in the RAM 63, as the cumulative ink consumption amount.

After S82, S85, and S89 are performed, the controller 60 ends the dot count process. The cumulative ink consumption amounts obtained in S82, S85, and S89 are used in various processes of the printer 10. For example, the controller 60 displays on the display 16 that the cartridge 37 is to be replaced based on the cumulative ink consumption amounts.

The sensor dot count C1 is an example of a first consumption amount. S88 is an example of a process of calculating the first consumption amount. The sensor dot count C2 is an example of a second consumption amount. S84 and S87 are examples of a process of calculating the second consumption amount. The cumulative ink consumption amount is an example of a cumulative liquid consumption amount. S85 and S89 are examples of a process of calculating the cumulative liquid consumption amount.

### Operation and Effect

As described above, the printer 10 according to the present illustrative embodiment includes the sub-tank 35, the head 32 including the plurality of nozzles 33, the first sensor 41, and the controller 60. The plurality of nozzles 33 form a plurality of nozzle rows arranged in the sub-scanning direction. The controller 60 performs the first maintenance process (the process in which a maintenance process is performed on a part of the nozzle rows) in response to receiving a high level signal after a low level signal is received from the first sensor 41, performs the second maintenance process (the process in which a maintenance process is performed on the remaining nozzle rows) in response to a predetermined condition being satisfied after the first maintenance process is performed, and performs the discharge process of discharging ink from the plurality of nozzles 33 onto a sheet after the first maintenance process and the second maintenance process are performed.

Accordingly, by performing the maintenance process on a part of the nozzle rows in advance in response to the cartridge 37 being mounted and the liquid level of the ink reaching the position of the first sensor 41, and then performing the maintenance process on the remaining nozzle rows in response to the predetermined condition being satisfied, in a case where the cartridge 37 is mounted and new ink is supplied, the maintenance process can be started at an early stage and discharge of the ink can be started at an early stage.

Each of the plurality of nozzle rows has an exhaust port 71. The controller 60 performs the suction purge and the exhaust purge as the maintenance process of the head 32. In the first maintenance process, the controller 60 performs at least one of the suction purge and the exhaust purge on the part of the nozzle rows. As a result, in the first maintenance process, at least one of the suction purge and the exhaust purge can be performed on the part of the nozzle rows.

After the first maintenance process is performed, the controller 60 performs the second maintenance process in response to receiving the high level signal from the second sensor 42. By performing the second maintenance process in response to the liquid level of the ink reaching the position of the second sensor 42 after the first maintenance process is performed in this way, the second maintenance process can be performed after an amount of ink required for the second maintenance process is stored in the sub-tank 35.

The printer 10 further includes the display 16 that operates as a notification device. The controller 60 causes the notification device to operate in response to not receiving the high level signal from the second sensor 42 after the first maintenance process is performed. By making a notification in response to the liquid level of the ink not reaching the second position after the first maintenance process is performed, the user can take measures such as replacing the cartridge 37.

After the notification device is caused to operate, the controller 60 does not perform the first maintenance process in response to receiving the high level signal from first sensor 41, and performs the second maintenance process in response to receiving the high level signal from second sensor 42. Accordingly, when the first maintenance process has already been performed, ink to be consumed in the maintenance process can be saved by omitting the first maintenance process.

In the purge process, the controller 60 performs the third maintenance process in which the maintenance process is performed on all of the plurality of nozzle rows. When the third maintenance process is performed, the controller 60 performs the maintenance process with the ink having the first amount in response to receiving the high level signal from the second sensor 42, and performs the maintenance process with the ink having the second amount smaller than the first amount such that the third maintenance process can be performed with the ink supplied from the sub-tank 35 in response to receiving the low level signal from the second sensor 42 and the high level signal from the first sensor 41. When the liquid level of the ink is higher than the position of the first sensor 41 and lower than the position of the second sensor 42, the maintenance process can be performed on all of the plurality of nozzle rows with the ink supplied from the sub-tank 35 by performing the maintenance process with a smaller amount of ink than usual.

In the dot count process, the controller 60 performs a process of calculating the sensor dot count C1, a process of calculating the sensor dot count C2, and a process of calculating the cumulative ink consumption amount based on the sensor dot count C2 until the low level signal is received from the second sensor 42 and the low level signal is received from the first sensor 41, and based on the sensor dot count C1 and the fixed value (V2-V1) after the low level signal is received from the first sensor 41. Accordingly, calculation accuracy of the cumulative ink consumption amount can be improved by using the ink consumption amount calculated when the liquid level of the ink is lowered to a predetermined position.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Various modifications can be made to the printer 10 according to the above illustrative embodiment. The first sensor 41 and the second sensor 42 of the printer 10 output signals corresponding to the liquid level of the ink stored in the sub-tank 35. In a printer according to a modification, a liquid level sensor may output a signal corresponding to a liquid level of ink stored in a cartridge that supplies ink to a tank. The liquid level sensor may output a signal corresponding to a liquid level of ink stored in a cartridge or a tank that supplies ink to the tank.

The controller 60 of the printer 10 performs the exhaust purge of the first nozzle row K1 in the first maintenance process performed in response to the first sensor 41 changing from OFF to ON. A controller of the printer according to the modification may perform the suction purge of the first nozzle row K1 in the first maintenance process, or may perform a part of the exhaust purge or the suction purge of the second to fourth nozzle rows K2 to K4. In the first maintenance process, the controller of the printer according to the modification may perform at least one of the suction purge and the exhaust purge on one or more of a part of the plurality of nozzle rows. In this case, the first sensor 41 may be disposed at a position where an amount of ink required for the first maintenance process can be detected. In addition, the second sensor 42 may be disposed at a position where an amount of ink required for the second maintenance process can be detected.

The controller 60 of the printer 10 performs the second maintenance process in response to the signal received from the second sensor 42 being a high level signal after the first maintenance process is performed. In this configuration, “the signal received from the second sensor 42 being a high level signal (third signal)” is an example of the predetermined condition. The controller of the printer according to the modification may perform the second maintenance process in response to that a predetermined time has elapsed since the high level signal is received from the first sensor 41 after the first maintenance process is performed. In this case, “a predetermined time has elapsed from reception of the high level signal from the first sensor 41” is an example of the predetermined condition. The printer according to the modification may include at least the first sensor 41, and does not necessarily include the second sensor 42.

When a predetermined time has elapsed since the liquid level of the ink reached the position of the first sensor 41, it is expected that the sub-tank 35 stores the amount of ink required for the second maintenance process. By performing the second maintenance process at this point in time, a timing of performing the second maintenance process can be known using one liquid level sensor.

The printer 10 includes, as a tank, the sub-tank 35 that is connected to the cartridge 37 and stores the ink supplied from the cartridge 37 (cartridge model). In the cartridge model printer, new ink is supplied to the printer by mounting a new cartridge 37 in the mounting case 36. The printer according to the modification may include a tank having an ink inlet (which may be called as a tank model printer) instead of the sub-tank 35. In the tank model printer, new ink is supplied to the printer by the user pouring ink accommodated in an ink bottle into an inlet of a tank.

The printer 10 performs the initial introduction purge process as the maintenance process of the head 32. The printer 10 may perform a regular maintenance process as the maintenance process of the head 32, or may perform a maintenance process at a timing instructed by the user.

The maintenance mechanism 51 of the printer 10 includes the four nozzle caps 52 and the exhaust port cap 53, with the exhaust port cap 53 corresponding to the four exhaust ports. A maintenance mechanism of the printer according to the modification may include a nozzle cap facing the first nozzle row K1 and nozzle caps corresponding to the second to fourth nozzle rows K2 to K4 in order to perform the exhaust purge for the first nozzle row K1 and the exhaust purge for the second to fourth nozzle rows K2 to K4 at different timings. In addition, the maintenance mechanism of the printer according to the modification may include four exhaust port caps corresponding to the four exhaust ports.

What is claimed is:

1. A liquid discharge device comprising:
a tank configured to store a liquid;
a head having a plurality of nozzles configured to discharge the liquid supplied from the tank, the plurality of nozzles forming a plurality of nozzle rows arranged in a first direction;
a first sensor configured to output a signal in accordance with a liquid level of the liquid stored in the tank or of a cartridge supplying the liquid to the tank, the first sensor being configured to:
output a first signal in a case the liquid level is at or above a first position; and
output a second signal in a case the liquid level is below the first position; and
a controller configured to:
based on receiving the first signal after receiving the second signal from the first sensor, perform a first maintenance on a part of the nozzle rows of the head;
in a case a predetermined condition is satisfied after performing the first maintenance, perform a second maintenance on remaining nozzle rows of the head; and
after performing the first maintenance and the second maintenance, control the head to discharge the liquid from the plurality of nozzles onto a sheet.

2. The liquid discharge device according to claim 1,
wherein each of the plurality of nozzle rows has an exhaust port, and
wherein the controller is configured to perform a maintenance process of the head comprising:
suction purge for sucking the nozzles in the nozzle row; and
exhaust purge for sucking the exhaust port of the nozzle row, and
wherein in the performing of the first maintenance, the controller is configured to perform at least one of the suction purge and the exhaust purge on the part of the nozzle rows.

3. The liquid discharge device according to claim 1, further comprising:
a second sensor configured to:
output a third signal in a case the liquid level is at or above a second position, the second position being higher than the first position; and
output a fourth signal in a case the liquid level is below the second position,
wherein after performing the first maintenance, based on receiving the third signal from the second sensor, the controller is configured to perform the second maintenance.

4. The liquid discharge device according to claim 3, further comprising:
a notification device,
wherein after performing the first maintenance, based on not receiving the third signal from the second sensor, the controller is configured to operate the notification device.

5. The liquid discharge device according to claim 4, wherein after operating the notification device, the controller is configured to:
based on receiving the first signal from the first sensor, not to perform the first maintenance; and
based on receiving the third signal from the second sensor, perform the second maintenance.

6. The liquid discharge device according to claim 3,
wherein the controller is configured to perform a third maintenance comprising performing a maintenance on all of the plurality of nozzle rows, and
wherein in the performing of the third maintenance, the controller is configured to:
based on receiving the third signal from the second sensor, perform the maintenance with a liquid having a first amount; and
based on receiving the fourth signal from the second sensor and the first signal from the first sensor, perform the maintenance with a liquid having a second amount, the second amount being smaller than the first amount, in order to perform the third maintenance with the liquid supplied from the tank.

7. The liquid discharge device according to claim 3, wherein the controller is configured to:
calculate a first consumption amount, the first consumption amount being a consumption amount of the liquid after the signal received from the first sensor is changed from the first signal to the second signal;
calculate a second consumption amount, the second consumption amount being a consumption amount of the liquid after the signal received from the second sensor is changed from the third signal to the fourth signal; and
calculate a cumulative liquid consumption amount, comprising:
until receiving the second signal from the first sensor after receiving the fourth signal from the second sensor, calculating the cumulative liquid consumption amount based on the second consumption amount; and
after receiving the second signal from the first sensor, calculating the cumulative liquid consumption amount based on the first consumption amount and a fixed value.

8. The liquid discharge device according to claim 1, wherein after performing the first maintenance, in a case a predetermined time has elapsed since receiving the first signal from the first sensor, the controller is configured to perform the second maintenance.
